(19) United States
(12) Patent Application Publication
(10) Pub. No.: US 2014/0126944 A1
(43) Pub. Date: May 8, 2014

(54) SHEET PROCESSING APPARATUS, CONTROL METHOD THEREFOR, AND STORAGE MEDIUM

(71) Applicant: CANON KABUSHIKI KAISHA, Tokyo (JP)

(72) Inventor: Yusuke Kimura, Kokubunji-shi (JP)

(73) Assignee: CANON KABUSHIKI KAISHA, Tokyo (JP)

(21) Appl. No.: 14/058,941

(22) Filed: Oct. 21, 2013

(30) Foreign Application Priority Data
Nov. 5, 2012 (JP) 2012-243852

(51) Int. Cl. G03G 15/00

(52) U.S. Cl. CPC G03G 15/6555
USPC 399/405

(57) ABSTRACT

A present sheet processing apparatus controls to stack sheets on a sheet stack unit and controls to align sheets by a plurality of alignment members. When the alignment unit cannot align sheets, the apparatus prompts a user to move the alignment members.

### BACKGROUND OF THE INVENTION

1. Field of the Invention

The present invention relates to a sheet processing apparatus that has a function of aligning sheets stacked on a stack tray, a control method for the sheet processing apparatus, and a storage medium.

2. Description of the Related Art

For sheet processing apparatuses that stack a large number of sheets, there has been demand for the ability to discharge and align the sheets with a high degree of accuracy. Japanese Patent Laid-Open No. 2006-206331 suggests a sheet alignment process in which line up members are provided on a stack tray, and sheets are piled up in such a manner that the positions of edge surfaces of the sheets parallel to a sheet discharge direction are lined up by the line up members coming into and out of contact with the edge surfaces of the sheets.

However, this conventional technique has the following problem. In the case where trouble occurs in alignment plates to the extent that the alignment plates cannot be moved, when the interval between the alignment plates is smaller than the width of sheets to be discharged, the sheets interfere with the alignment plates at the time of discharge. This may damage the output materials or trigger the occurrence of a paper jam.

### SUMMARY OF THE INVENTION

The present invention enables realization of a mechanism to prevent damage to sheets and the occurrence of a paper jam by, upon detection of trouble in alignment units, prompting an operator to move the alignment units so that the sheets can be discharged.

One aspect of the present invention provides a sheet processing apparatus, comprising: a stacking control unit configured to control to stack sheets on a sheet stacking unit; an alignment control unit configured to control to align, by a plurality of alignment members, the sheets stacked on the sheet stacking unit; a determination unit configured to determine whether or not the alignment members can align sheets; and a control unit configured to prompt, in a case where the determination unit determines that the alignment unit cannot align sheets, a user to move the alignment members.

Another aspect of the present invention provides a control method comprising: controlling to stack sheets on a sheet stacking unit; controlling to align, by a plurality of alignment members, the sheets stacked on the sheet stacking unit; determining whether or not the alignment members can align sheets; and prompting, in a case where the alignment members cannot align sheets, a user to move the alignment members.

Still another aspect of the present invention provides a non-transitory computer-readable storage medium storing a computer program for causing a computer to execute the control method for the sheet processing apparatus.

Further features of the present invention will be apparent from the following description of exemplary embodiments with reference to the attached drawings.

### BRIEF DESCRIPTION OF THE DRAWINGS

FIG. 1 is a configuration diagram showing a cross-sectional configuration of main parts of an image forming system according to embodiments.

FIG. 2 is a block diagram showing configurations of controllers that control the entirety of the image forming system according to embodiments.

FIG. 3 is a diagram for describing an operation display unit 400 in an image forming apparatus according to embodiments.

FIG. 4A is diagram for describing a configuration of a finisher according to embodiments, as viewed from the front.

FIG. 4B is a diagram for describing the configuration of the finisher according to embodiments, as viewed in a direction opposing a sheet discharge direction.

FIG. 5 is a block diagram showing a configuration of a finisher control unit according to embodiments.

FIG. 6A shows a positional relationship between a stack tray and alignment plates in the state where sheets are aligned by the alignment plates.

FIG. 6B shows a positional relationship between a stack tray and alignment plates in the state where the alignment plates are retracted.

FIG. 7 is a diagram for describing the conveyance of sheets in the finisher according to embodiments.

FIGS. 8A to 8D are diagrams for describing sheet alignment operations on a discharge tray during a sort mode according to embodiments.

FIGS. 9A to 9G are diagrams for describing sheet alignment operations on a discharge tray during a shift-sort mode according to embodiments

FIGS. 10A to 10C show selection screens for a finish mode according to embodiments.

FIG. 11 shows a sheet feeder selection screen according to embodiments.

FIG. 12 is a flowchart according to the first embodiment.

FIG. 13 is a flowchart according to the second embodiment.

FIG. 14 shows an instruction screen according to the first embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

<Overall Configuration>

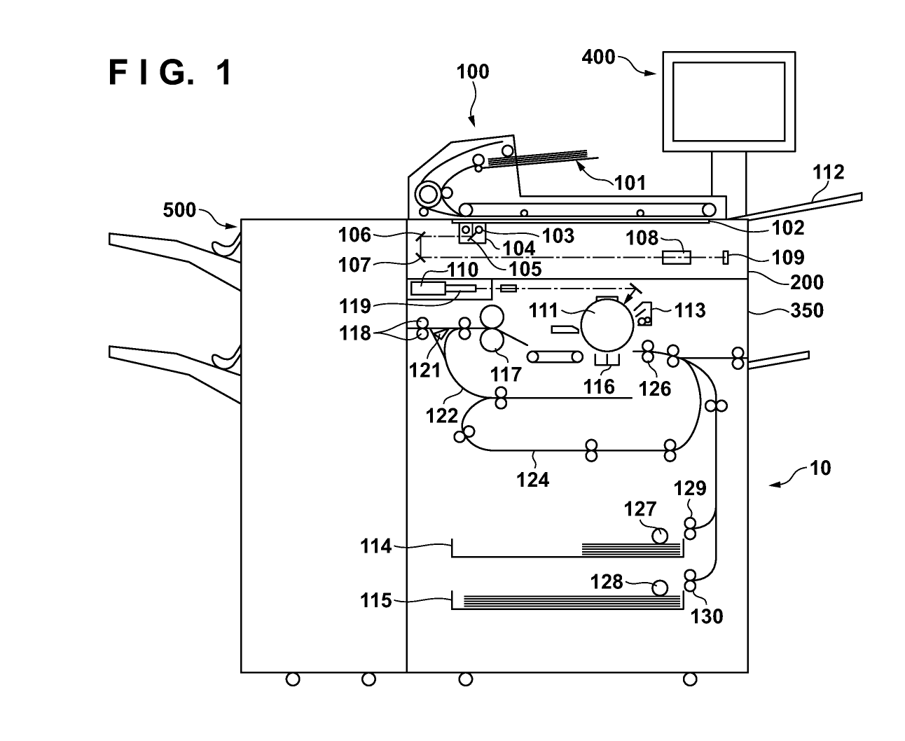

FIG. 1 is a configuration diagram showing a cross-sectional configuration of main parts of an image forming system according to embodiments of the present invention.

This image forming system includes an image forming apparatus 10 and a finisher 500 which serves as a sheet stacker. In the image forming system (sheet processing apparatus) described herein, the finisher 500 is connected to the image forming apparatus 10. It should be noted, however, that the present invention is not limited in this way, and is applicable to any sheet processing apparatus with a mechanism to discharge and stack sheets. That is to say, the image forming system, the image forming apparatus and the sheet stacker can each serve as an example of the sheet processing apparatus. The image forming apparatus 10 includes an image reader 200 that reads an image from an original, and a printer 350 that forms (prints) the read image on a sheet.

An original supply apparatus 100 feeds originals set on an original tray 101 one by one in order starting from the top original, conveys the originals along a curved path and past a predetermined pickup position on a glass platen 102, then discharges the originals onto a discharge tray 112. Note that the originals are set on the original tray 101 with their front sides up. At this time, a scanner unit 104 is fixed at a predetermined reading position. When an original passes the reading position, an image of the original is read by the scanner unit 104. When the original passes the reading position, the original is irradiated with light from a lamp 103 in the scanner unit 104, and reflected light from the original is directed to a lens 108 via mirrors 105, 106 and 107. Light that has passed through this lens 108 is focused on an imaging surface of an image sensor 109, converted into image data, and output. The image data output from the image sensor 109 is input as a video signal to an exposure unit 110 in the printer 350.

The exposure unit 110 in the printer 350 outputs laser light that has been modulated based on a video signal input from the image reader 200. A photosensitive drum 111 is irradiated with and scanned by this laser light using a polygon mirror 119. An electrostatic latent image corresponding to the laser light that has scanned the photosensitive drum 111 is formed on the photosensitive drum 111. This electrostatic latent image on the photosensitive drum 111 turns into a visible image by being developed using the developer supplied from a developing apparatus 113.

Sheets used in the printing are picked up one by one from a sheet feeder 114 or 115, which is provided in the printer 350, by rotation of a pickup roller 127 or 128. The sheets thus picked up are conveyed to the position of registration rollers 126 by rotation of sheet feeding rollers 129 or 130. Although FIG. 1 shows only two sheet feeders for the sake of explanation, the printer 350 may include other sheet feeders that are not shown in the figures. Furthermore, additional sheet feeders may be provided by connecting an optional sheet feeding apparatus not shown in the figures to the printer 350. When the leading edge of a sheet arrives at the position of the registration rollers 126, the registration rollers 126 are driven and rotated at a predetermined timing so as to convey the sheet between the photosensitive drum 111 and a transfer unit 116. Accordingly, a developer image formed on the photosensitive drum 111 is transferred to the fed sheet (to the first side of the fed sheet) by the transfer unit 116. The sheet to which the developer image has been thus transferred is conveyed to a fixing unit 117. The fixing unit 117 fixes the image on the sheet by applying heat and pressure to the sheet. The sheet that has passed the fixing unit 117 is discharged to the outside of the printer 350 (to the finisher 500) via a flapper 121 and discharge rollers 118. In the case where images are formed on both sides of the sheet, the sheet is conveyed to a double-sided conveyance path 124 via a reverse path 122, then conveyed to the position of the registration rollers 126 again. Thereafter, an image for the second side, which has been formed on the transfer unit 116, is transferred to the second side of the sheet using the photosensitive drum 111. Then, the sheet to which the image has been transferred is conveyed to the fixing unit 117, and the image on the sheet is fixed by the fixing unit 117. The sheet that has passed the fixing unit 117 is discharged to the outside of the printer 350 (to the finisher 500) via the flapper 121 and the discharge rollers 118.

<Controller>

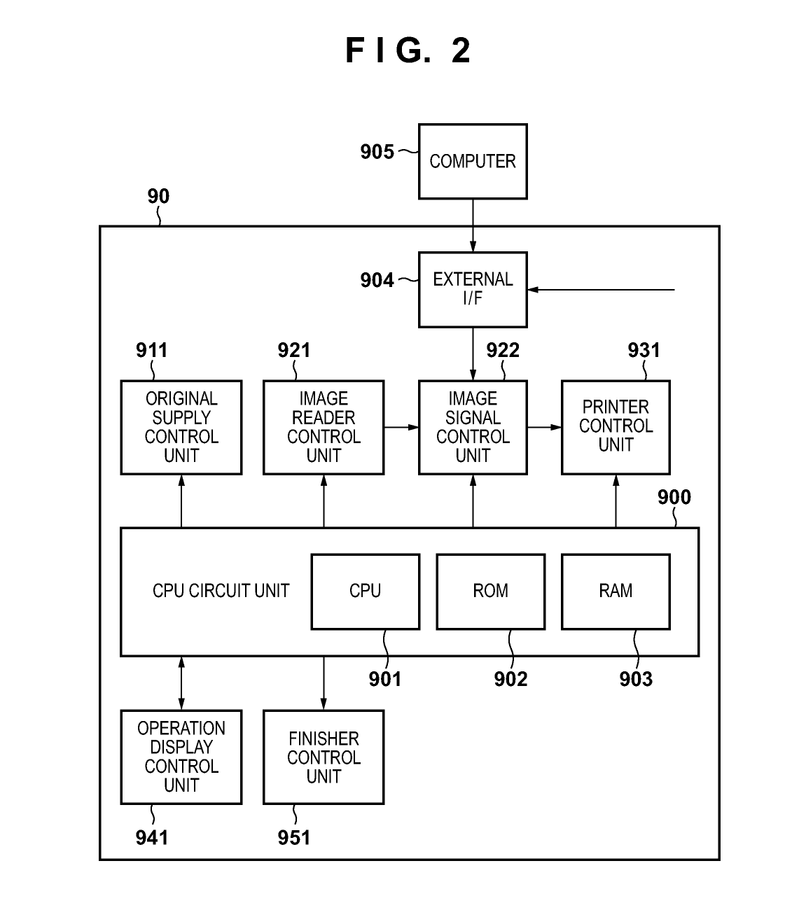

The following describes a configuration of a controller unit 90 that controls the entirety of the present image forming system with reference to FIG. 2.

As shown in FIG. 2, the controller unit 90 includes a CPU circuit unit 900 in which a CPU 901, a ROM 902 and a RAM 903 are built. The controller unit 90 also includes a storage unit 961. The CPU 901 performs basic control of the entirety of the present image forming system, and is connected to the ROM 902 in which control programs are written and to the RAM 903 used for processing via an address bus and a data bus. The CPU 901 also performs overall control of control units 911, 921, 922, 904, 931, 941 and 951 based on the control programs stored in the ROM 902. The RAM 903 temporarily holds control data and is used as a working area for calculation processing associated with control.

An original supply control unit 911 controls driving of the original supply apparatus 100 based on instructions from the CPU circuit unit 900. An image reader control unit 921 controls driving of the above-described scanner unit 104, image sensor 109, and the like, and transfers an image signal output from the image sensor 109 to an image signal control unit 922. The image signal control unit 922 converts an analog image signal from the image sensor 109 into a digital signal, applies various types of processing to the digital signal, converts the digital signal into a video signal, and outputs the video signal to a printer control unit 931. The image signal control unit 922 also converts a digital image signal input from a computer 905 via an external I/F 904 into a video signal by applying various types of processing to the digital image signal, and outputs the video signal to the printer control unit 931. The operations of processing executed by this image signal control unit 922 are controlled by the CPU circuit unit 900.

The printer control unit 931 controls the exposure unit 110 and the printer 350 based on an input video signal so as to form images and convey sheets. A finisher control unit 951 is mounted on the finisher 500, and controls driving of the entirety of the finisher 500 by exchanging information with the CPU circuit unit 900. The details of this control will be described later. An operation display control unit 941 exchanges information with an operation display unit 400 and the CPU circuit unit 900. The operation display unit 400 includes, for example, a plurality of keys for setting various types of functions related to image formation, and a display unit for displaying information showing the states of settings. Key signals corresponding to operations applied to the keys are output to the CPU circuit unit 900. Based on signals from the CPU circuit unit 900, corresponding information is displayed on the operation display unit 400. The storage unit 961 is constituted by an HDD and the like, and stores image data to be printed and software programs executed by the CPU 901.

<Operation Display Unit>

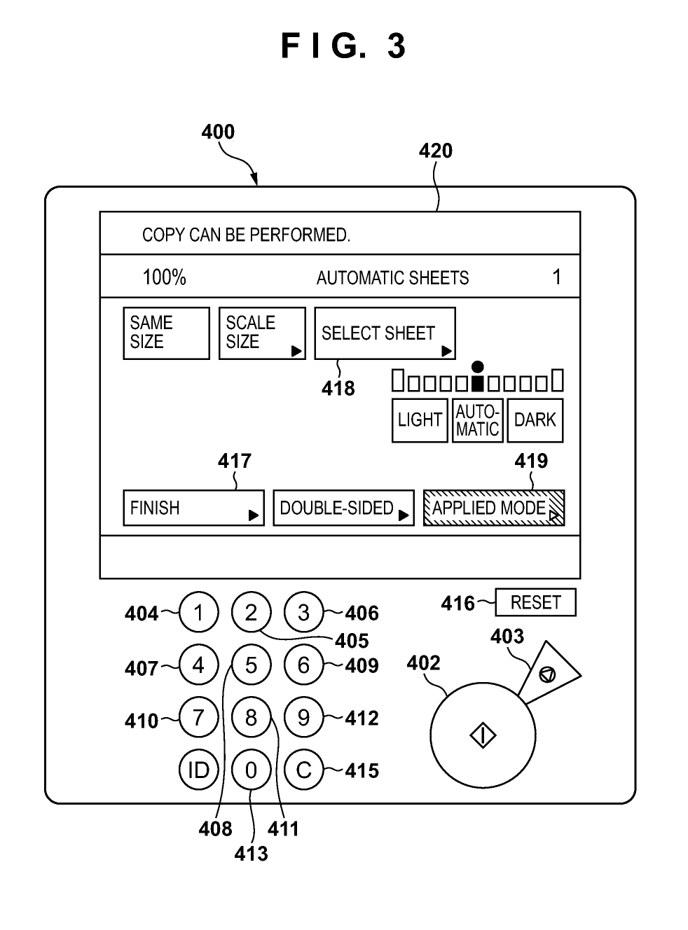

FIG. 3 is a diagram for describing the operation display unit 400 in the image forming apparatus according to embodiments.

For example, a start key 402, a stop key 403, numeric keys 404 to 413, a clear key 415, and a reset key 416 are arranged on the operation display unit 400. The start key 402 is used to start the image forming operations. The stop key 403 is used to interrupt the image forming operations. The numeric keys 404 to 413 are used to, for example, enter numbers. A display unit 420 is also arranged on the operation display unit 400. A touchscreen is formed on the upper part of the display unit 420. Software keys can be generated on a screen of the display unit 420.

This image forming apparatus includes various process modes as post-process modes, including no sort, sort, shift-sort, staple-sort (bind mode), and the like. The settings and the like for these process modes are input from the operation display unit 400. For example, a post-process mode is set as follows. When a “Finish” software key 417 is selected on a default screen shown in FIG. 3, a menu selection screen is displayed on the display unit 420. On this menu selection screen, a process mode is set.

<Finisher>

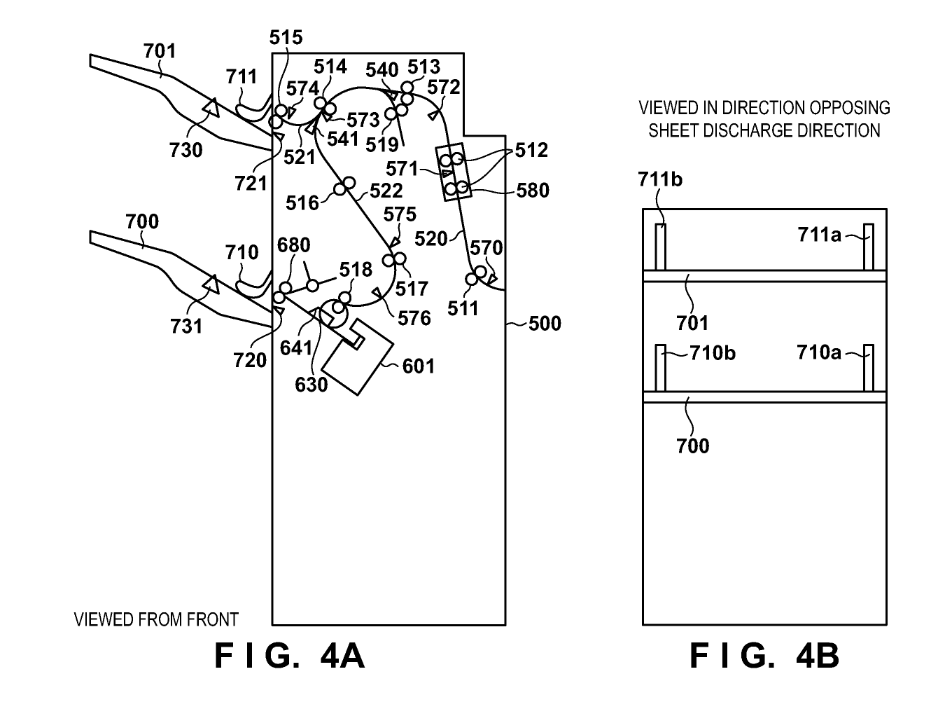

The following describes a configuration of the finisher 500 with reference to FIGS. 4A and 4B. FIGS. 4A and 4B are diagrams for describing a configuration of the finisher 500 according to embodiments. FIG. 4A shows the finisher 500 as viewed from the front, and FIG. 4B shows stack trays 700 and 701 in the finisher 500 as viewed in a direction opposing a sheet discharge direction.

First, a description is provided with reference to FIG. 4A.

The finisher 500 receives sheets discharged from the image forming apparatus 10 in order, and executes post-processes such as a process for aligning the plurality of received sheets in a bundle, and a staple process for binding the trailing edges of the bundle of sheets using a stapler. The finisher 500 receives a sheet discharged from the image forming apparatus 10 along a conveyance path 520 using a pair of conveyance rollers 511. The sheet that has been received using the pair of conveyance rollers 511 is conveyed via pairs of conveyance rollers 512, 513 and 514. Conveyance sensors 570, 571, 572 and 573 are provided on the conveyance path 520 to detect passing of the sheet. The pair of conveyance rollers 512 is provided in a shift unit 580 together with the conveyance sensor 571.

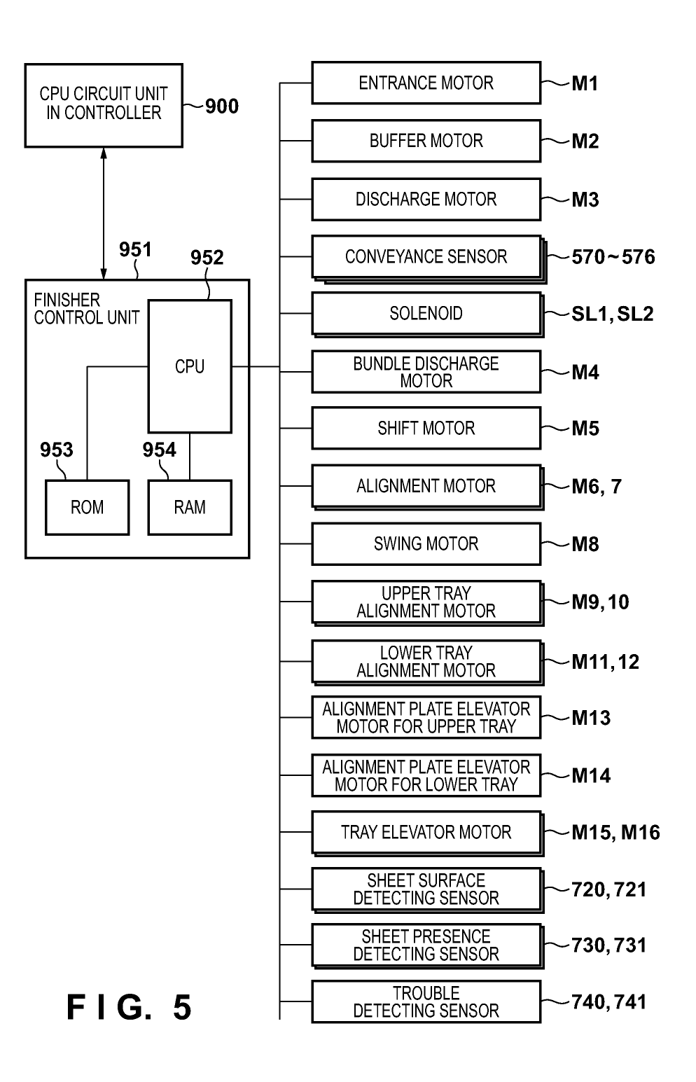

The shift unit 580 can move the sheet in a sheet width direction orthogonal to a sheet conveyance direction using a later-described shift motor M5 (FIG. 5). By driving the shift motor M5 while the pair of conveyance rollers 512 is holding the sheet therebetween, the sheet can be offset in the width direction while being conveyed. In a shift-sort mode, the position of a bundle of sheets is moved in the width direction on a per-copy basis. For example, an offset amount of 15 mm toward the front (front shift), or an offset amount of 15 mm toward the back (back shift), is set with respect to the center position in the width direction. When no designation is made regarding the shift, sheets are discharged at the same position as in the front shift.

When the finisher 500 detects that a sheet has passed the shift unit 580 based on the input from the conveyance sensor 571, the finisher 500 drives the shift motor M5 (FIG. 5) to place the shift unit 580 back to the center position. A switching flapper 540, which directs a sheet conveyed in a reverse fashion by the pair of conveyance rollers 514 to a buffer path 523, is arranged between the pair of conveyance rollers 513 and the pair of conveyance rollers 514. The switching flapper 540 is driven by a later-described solenoid SL1 (FIG. 5).

A switching flapper 541, which switches between an upper discharge path 521 and a lower discharge path 522, is arranged between the pair of conveyance rollers 514 and the pair of conveyance rollers 515. The switching flapper 541 is driven by the later-described solenoid SL1. When the switching flapper 541 switches to the upper discharge path 521, a sheet is directed to the upper discharge path 521 by the pair of conveyance rollers 514 which is driven and rotated by a buffer motor M2 (FIG. 5). Then, the sheet is discharged onto the stack tray (discharge tray) 701 by the pair of conveyance rollers 515 which is driven and rotated by a discharge motor M3 (FIG. 5). A conveyance sensor 574 is provided on the upper discharge path 521 to detect passing of the sheet. When the switching flapper 541 switches to the lower discharge path 522, the sheet is directed to the lower discharge path 522 by the pair of conveyance rollers 514 which is driven and rotated by the buffer motor M2. This sheet is further directed to a process tray 630 by pairs of conveyance rollers 516 to 518 which are driven and rotated by the discharge motor M3. Conveyance sensors 575 and 576 are provided on the lower discharge path 522 to detect passing of the sheet. The sheet that has been directed to the process tray 630 is discharged onto the process tray 630 or the stack tray 700, in accordance with a post-process mode, by a pair of bundle discharge rollers 680 driven and rotated by a bundle discharge motor M4 (FIG. 5).

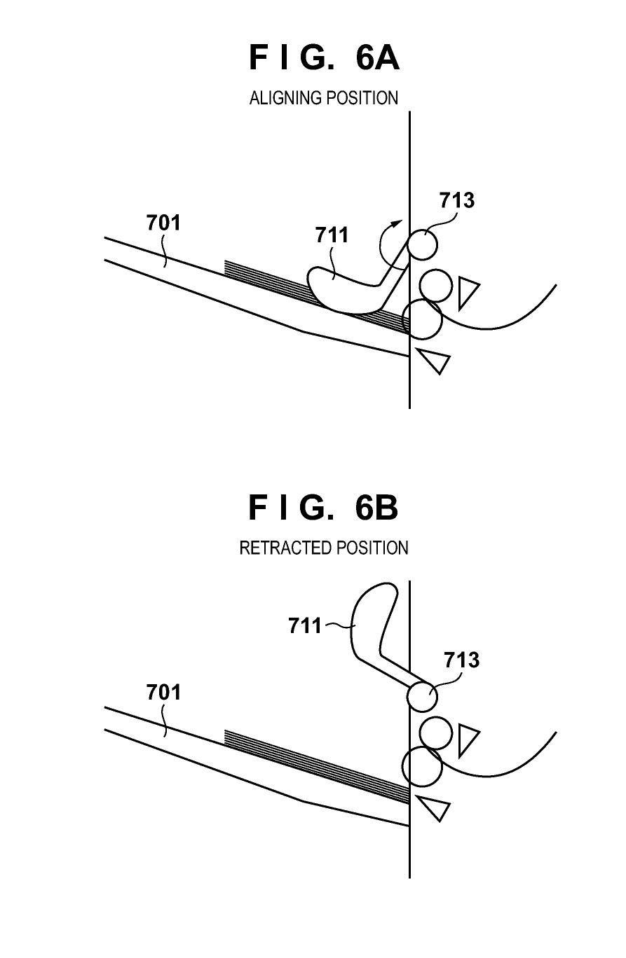

Furthermore, an alignment plate 711a (first alignment member) and an alignment plate 711b (second alignment member) are arranged on the stack tray 701 as shown in FIG. 4B. The alignment plates 711a and 711b are alignment members for aligning sheets discharged onto the stack tray 701 in the sheet width direction by coming into contact with both side edges of the sheets. Note that the both side edges of the sheets denote the side surfaces thereof parallel to the sheet conveyance direction. These alignment plates 711a and 711b are represented by a reference sign 711 in FIG. 4A. Similarly, alignment plates 710a and 710b are arranged on the stack tray 700. The alignment plates 710a and 710b are used to align sheets discharged onto the stack tray 700 in the sheet width direction. The alignment plates 710a and 710b, which are represented by a reference sign 710 in FIG. 4A, can be moved in the sheet width direction respectively by later-described lower tray alignment motors M11 and M12 (FIG. 5). In FIG. 4A, the alignment plates 710a and 710b are arranged respectively in the front and the back. On the other hand, the alignment plates 711a and 711b are similarly driven respectively by later-described upper tray alignment motors M9 and M10 (FIG. 5). In FIG. 4A, the alignment plates 711a and 711b are arranged respectively in the front and the back. Furthermore, the alignment plates 710 and 711 are moved up and down about an alignment plate axis 713 between aligning positions where they actually execute an alignment process (FIG. 6A) and waiting positions where they wait (FIG. 6B). The alignment plates 710 and 711 are thus moved respectively by an alignment plate elevator motor M13 for the upper tray (FIG. 5) and an alignment plate elevator motor M14 for the lower tray (FIG. 5), which will be described later.

The stack trays 700 and 701 can be raised and lowered by later-described tray elevator motors M15 and M16 (FIG. 5). The topmost surface of a tray or sheets on a tray is detected by later-described sheet surface detecting sensors 720 and 721 (FIG. 4A). The finisher 500 performs control so that this topmost surface of a tray or sheets on a tray is always located at a certain position by driving and rotating the tray elevator motors M15 and M16 in accordance with the input from the sheet surface detecting sensors 720 and 721. Furthermore, sheet presence sensors 730 and 731 (FIG. 4A) detect whether or not there is any sheet on the stack trays 701 and 700.

<Finisher Control Unit>

A description is now given of a configuration of the finisher control unit 951 that controls driving of the finisher 500 with reference to FIG. 5. FIG. 5 is a block diagram showing a configuration of the finisher control unit 951 according to embodiments.

The finisher control unit 951 includes a CPU 952, a ROM 953, a RAM 954, and the like. The finisher control unit 951 controls driving of the finisher 500 by communicating with the CPU circuit unit 900, exchanging data with the CPU circuit unit 900, and executing various types of programs stored in the ROM 953. The data exchange denotes, for example, transmission/reception of commands, exchange of job information, and notification of sheet transfer. The following describes various types of inputs and outputs of the finisher 500.

In order to convey sheets, the finisher 500 includes an entrance motor M1 that drives and rotates the pairs of conveyance rollers 511 to 513, a buffer motor M2, a discharge motor M3, a shift motor M5, solenoids SL1 and SL2, and conveyance sensors 570 to 576. The finisher 500 also includes, as a means to drive various types of members in the process tray 630 (FIG. 4A), a bundle discharge motor M4 that drives the pair of bundle discharge rollers 680. The finisher 500 further includes, as means to drive various types of members in the process tray 630 (FIG. 4A), alignment motors M6 and M7 that drive alignment members 641 (FIG. 4A) and a swing guide motor M8 that drives a swing guide to be raised and lowered. The finisher 500 further includes tray elevator motors M15 and M16 for raising and lowering the stack trays 700 and 701, sheet surface detecting sensors 720 and 721 (FIG. 4A), and sheet presence sensors 730 and 731. In relation to alignment operations for sheets on the stack trays, the finisher 500 further includes upper tray alignment motors M9 and M10, lower tray alignment motors M11 and M12, an alignment plate elevator motor M13 for the upper tray, and an alignment plate elevator motor M14 for the lower tray. The finisher 500 further includes trouble detecting sensors 740 and 741 that detect trouble in M9 to M14 as shown in FIG. 5. The trouble detecting sensors 740 and 741 may be either optical sensors or mechanical sensors, as long as they can determine whether or not the alignment plates are operating normally in accordance with driving of the motors M9 to M14.

<Sort Operations>

The following describes a flow of sheets during a sort mode with reference to FIGS. 3, 7, 8A to 8D, 10A to 10C, and 11. When the user presses a “Select Sheet” key 418 on the default screen shown in FIG. 3 on the operation display unit 400 of the image forming apparatus 10, a sheet feeder selection screen shown in FIG. 11 is displayed on the display unit 420. On this sheet feeder selection screen, the user selects sheets to be used for a job. It is assumed here that the user selects the size “A4” corresponding to a sheet feeder 1. FIG. 11 shows one example of the sheet feeder selection screen on which the size “A4” is selected.

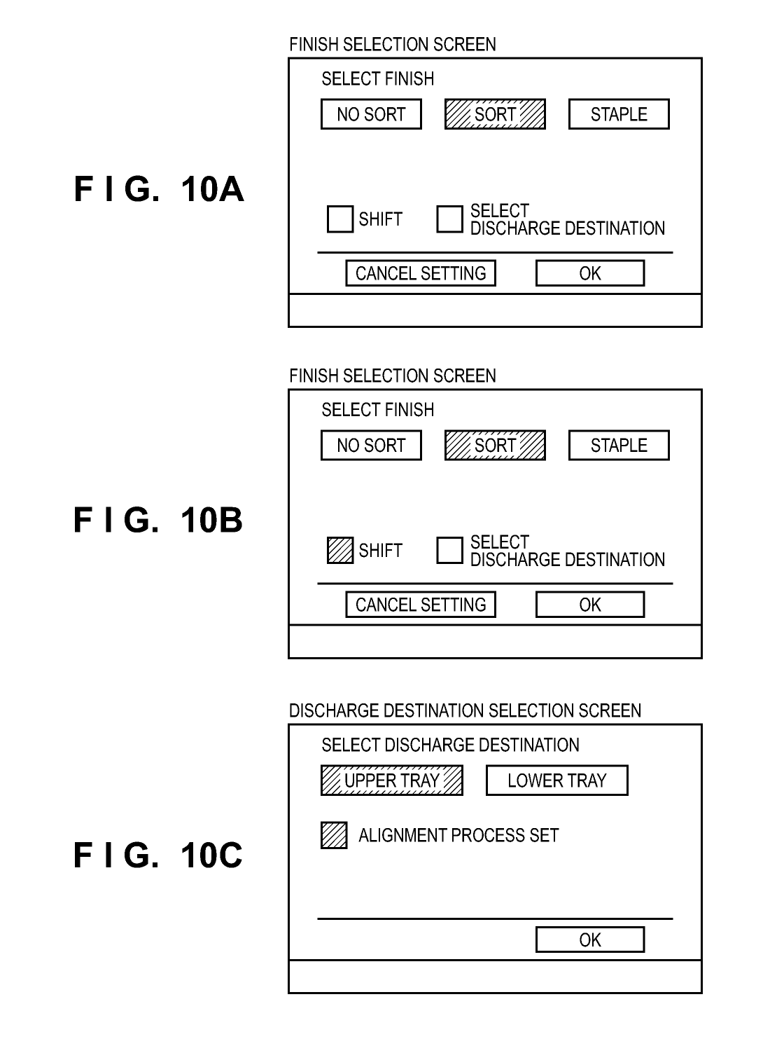

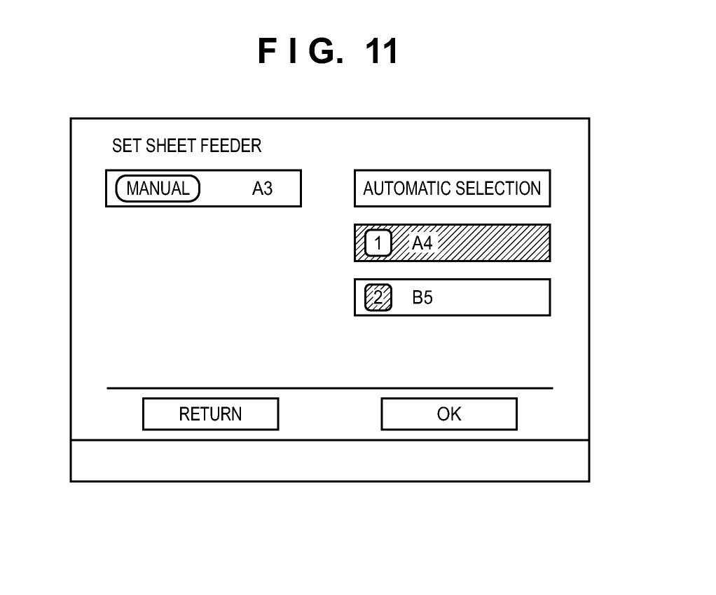

When the user selects the “Finish” software key 417 on the default screen shown in FIG. 3 on the operation display unit 400 of the image forming apparatus 10, a finish menu selection screen shown in FIG. 10A is displayed on the display unit 420. When the user presses an OK button while a “Sort” key is selected on the finish menu selection screen shown in FIG. 10A, the sort mode is set.

In order to offset a bundle of sheets on a per-copy basis, the user presses the OK button while a “Shift” key is selected on the finish menu selection screen shown in FIG. 10A; as a result, a shift mode is set.

Once the user has designated the sort mode and entered a job, the CPU 901 in the CPU circuit unit 900 notifies the CPU 952 in the finisher control unit 951 of information related to that job, such as the sheet size and the selection of the sort mode. In the embodiments, after sheets have been discharged in one print job, shift operations are applied to sheets printed in the next print job so that the sheets printed in the next print job are discharged at a different position from the sheets discharged in the previous job. Such shift operations applied for each print job are referred to as an inter-job shift.

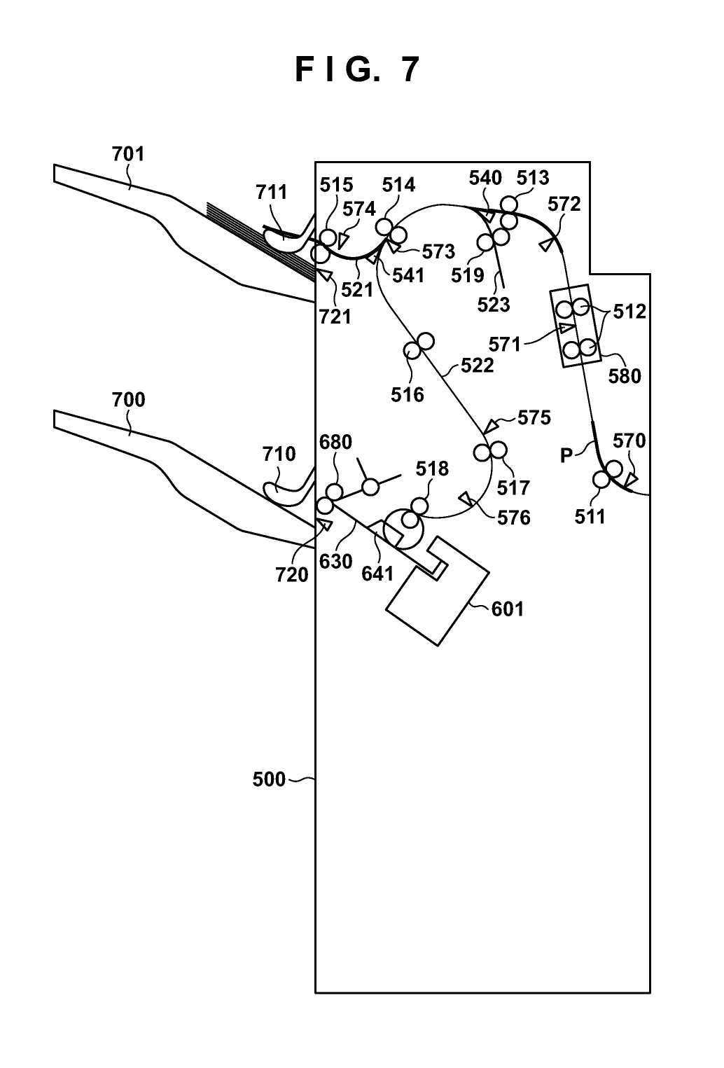

FIG. 7 is a diagram for describing the conveyance of sheets in the finisher according to embodiments. In FIG. 7, the parts that are shown in the above-described FIG. 4A are given the same reference signs thereas.

When the image forming apparatus 10 discharges a sheet P to the finisher 500, the CPU 901 in the CPU circuit unit 900 notifies the CPU 952 in the finisher control unit 951 of the start of sheet transfer. The CPU 901 also notifies the CPU 952 in the finisher control unit 951 of sheet information, such as shift information and sheet width information of the sheet P. Upon receiving the notification of the start of sheet transfer, the CPU 952 drives and rotates the entrance motor M1, the buffer motor M2 and the discharge motor M3. As a result, the pairs of conveyance rollers 511, 512, 513, 514 and 515 shown in FIG. 7 are driven and rotated, thus making the finisher 500 receive and transfer the sheet P discharged from the image forming apparatus 10. The conveyance sensor 571 detects the sheet P when the pair of conveyance rollers 512 holds the sheet P therebetween. Accordingly, the CPU 952 offsets the sheet P in the width direction by moving the shift unit 580 through driving of the shift motor M5. When the shift information included in the sheet information notified from the CPU 901 shows “no shift designation”, sheets are equally offset by 15 mm toward the front.

When the switching flapper 541 is driven and rotated by the solenoid S1 to be situated in the position shown in FIG. 7, the sheet P is directed to the upper discharge path 521. Then, when the conveyance sensor 574 detects passing of the trailing edge of the sheet P, the CPU 952 discharges the sheet P onto the stack tray 701 by driving and rotating the discharge motor M3 so that the sheet P is conveyed by the pair of conveyance rollers 515 at a speed suited for stacking.

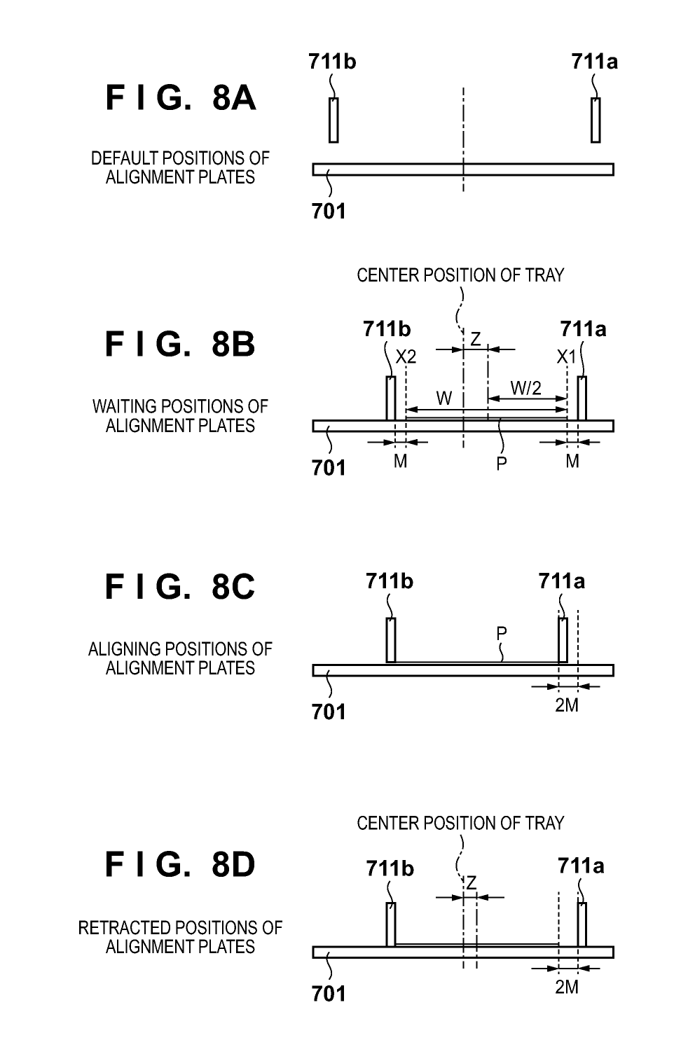

Next, a description is given of the alignment operations during a sort mode, using an example of the front shift operations, with reference to FIGS. 8A to 8D. These alignment operations are executed when an alignment process is selected in FIG. 10C. In other words, these alignment operations are not applied when an alignment process is not selected. FIGS. 8A to 8D are diagrams for describing the positions of the alignment plates 711a and 711b on the stack tray 701 as viewed in a direction opposing the sheet discharge direction.

As shown in FIG. 8A, before a job is started, the pair of alignment plates 711a and 711b waits at default positions. As shown in FIG. 8B, when the job is started, the front alignment plate 711a moves to an alignment waiting position that is distant from a front sheet edge position X1 by a predetermined retracted amount M. Note, the front sheet edge position X1 is distant from the center position of the stack tray 701 by a distance obtained by adding a shift amount Z to W/2 which is half of the sheet width. The alignment plate 711a waits at this alignment waiting position until a sheet is discharged. On the other hand, the back alignment plate 711b waits at an alignment waiting position that is distant from a back sheet edge position X2 by the predetermined retracted amount M. Note, the back sheet edge position X2 is distant from the center position of the stack tray 701 by a distance obtained by subtracting the shift amount Z from W/2 which is half of the sheet width. When a predetermined time period has elapsed since the sheet P was discharged onto the stack tray 701, the front alignment plate 711a moves toward the center of the stack tray 701 by a predetermined push amount 2M so as to press the sheet P against the stopped back alignment plate 711b as shown in FIG. 8C. As a result, the sheet P is moved toward the alignment plate 711b by the retracted amount M. When a predetermined period has elapsed since the sheet P was pressed against the alignment plate 711b in the above manner, the alignment plate 711a is retracted to the alignment waiting position as shown in FIG. 8D. More specifically, the alignment plate 711a is retracted away from the sheet P in the sheet width direction by 2M which is twice the retracted amount M, then waits until the next sheet is discharged onto the stack tray 701. Provided that the offset amount Z is 15 mm and the retracted amount M is 5 mm, the front alignment plate 711a pushes the sheet P by 5 mm during the alignment operations, and therefore the offset amount of the sheet P after the alignment operations is 10 mm. By repeating the above operations, a sheet P is aligned each time it is discharged onto the stack tray 701.

<Shift-Sort Operations>

The following describes a flow of sheets during a shift-sort mode with reference to FIGS. 3, 7, 9A to 9G, and 10A to 10C. The shift-sort mode is set when the OK key is pressed while the “Sort” and “Shift” keys are selected on the finish menu selection screen shown in FIG. 10B.

Once the user has designated the shift-sort mode and entered a job, the CPU 901 in the CPU circuit unit 900 notifies the CPU 952 in the finisher control unit 951 of the selection of the shift-sort mode, similarly to the case of a no sort mode. The following describes the operations for a shift-sort mode in the case where one “copy” is composed of three sheets.

When the image forming apparatus 10 discharges a sheet P to the finisher 500, the CPU 901 in the CPU circuit unit 900 notifies the CPU 952 in the finisher control unit 951 of the start of sheet transfer. Upon receiving the notification of the start of sheet transfer, the CPU 952 drives the entrance motor M1, the buffer motor M2 and the discharge motor M3. As a result, the pairs of conveyance rollers 511, 512, 513, 514 and 515 shown in FIG. 7 are driven and rotated, thus making the finisher 500 receive and transfer the sheet P discharged from the image forming apparatus 10. When the conveyance sensor 571 detects that the sheet P is held between the pair of conveyance rollers 512, the CPU 952 offsets the sheet P by moving the shift unit 580 through driving of the shift motor M5. The sheet P is offset by 15 mm toward the front when the shift information of the sheet P notified from the CPU 901 shows “front”, and by 15 mm toward the back when the shift information of the sheet P notified from the CPU 901 shows “back”.

The switching flapper 541 is driven and rotated by the solenoid S1 to be situated in the position shown in the figures, and the sheet P is directed to the upper discharge path 521. When the conveyance sensor 574 detects passing of the trailing edge of the sheet P, the CPU 952 discharges the sheet P onto the stack tray 701 by driving the discharge motor M3 so that the pair of conveyance rollers 515 is rotated at a speed suited for stacking.

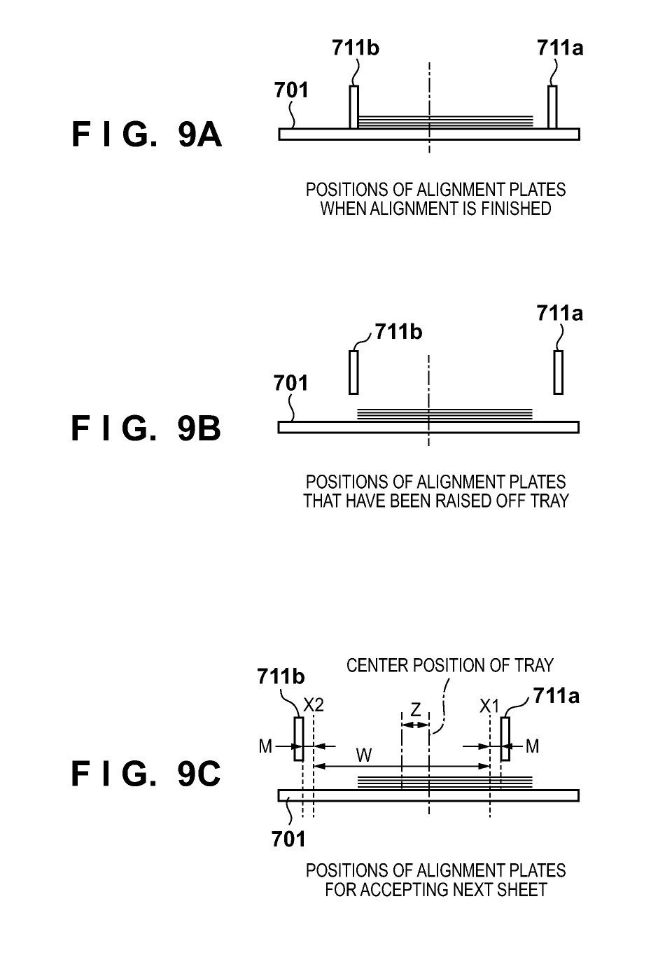

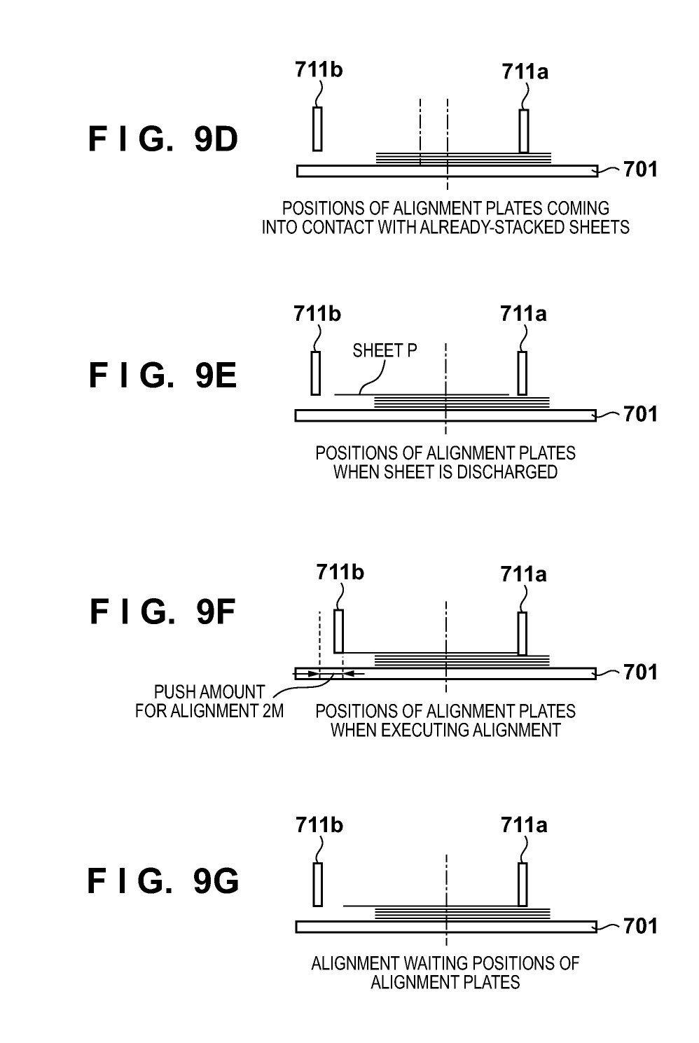

The following describes the operations of the alignment plates at the time of the shifting, using the exemplary case where the shift direction is changed from the front to the back, with reference to FIGS. 9A to 9G. FIGS. 9A to 9G show the stack tray 701 as viewed in a direction opposing the sheet discharge direction. When a retracting operation of the front alignment plate 711a is finished as shown in FIG. 9A, the alignment plates 711a and 711b are raised off the stack tray 701 by a predetermined amount as shown in FIG. 9B. Next, the alignment plates 711a and 711b move in the sheet width direction to their respective alignment waiting positions for the next sheet. As shown in FIG. 9C, the front alignment plate 711a moves to an alignment waiting position that is distant from the front sheet edge position X1 by the predetermined retracted amount M. Note, the front sheet edge position X1 is distant from the center position of the stack tray 701 by a distance obtained by subtracting the shift amount Z from W/2 which is half of the sheet width. The back alignment plate 711b moves to an alignment waiting position that is distant from the back sheet edge position X2 by the predetermined retracted amount M. Note, the back sheet edge position X2 is distant from the center position of the stack tray 701 by a distance obtained by adding the shift amount Z to W/2 which is half of the sheet width. Once the alignment plates 711a and 711b have moved to their respective alignment waiting positions, the alignment plates 711a and 711b move toward the stack tray 701 by a predetermined amount and wait until the next sheet is discharged onto the stack tray 701 as shown in FIG. 9D. At this time, the alignment plate 711a is in contact with the top surface of the already-stacked sheets.

When a predetermined time period has elapsed since a sheet P was discharged onto the stack tray 701 as shown in FIG. 9E, the alignment plate 711b moves toward the center of the stack tray 701 by the predetermined push amount 2M so as to press the sheet P against the alignment plate 711a as shown in FIG. 9F. When a predetermined time period has elapsed in the state of FIG. 9F, the alignment plate 711b is retracted away from the center of the stack tray 701 by the predetermined push amount 2M and waits until the next sheet is discharged onto the stack tray 701 as shown in FIG. 9G.

As described above, when the shift direction is changed, alignment plates are first raised off a stack tray in the upward direction, then lowered after changing the aligning positions; in this way, a sheet is aligned each time it is discharged onto the stack tray.

<Selection of Stack Tray (Discharge Tray)>

When a “Select Discharge Destination” key is selected on the finish menu selection screen shown in FIG. 10A, a discharge destination selection screen shown in FIG. 10C is displayed on the display unit 420. When the user selects a discharge destination and presses the OK key, the discharge destination is selected, and the finishing menu selection screen shown in FIG. 10A is displayed on the display unit 420.

### First Embodiment

### Discharge Operations Executed when Trouble Occurs in Alignment Units

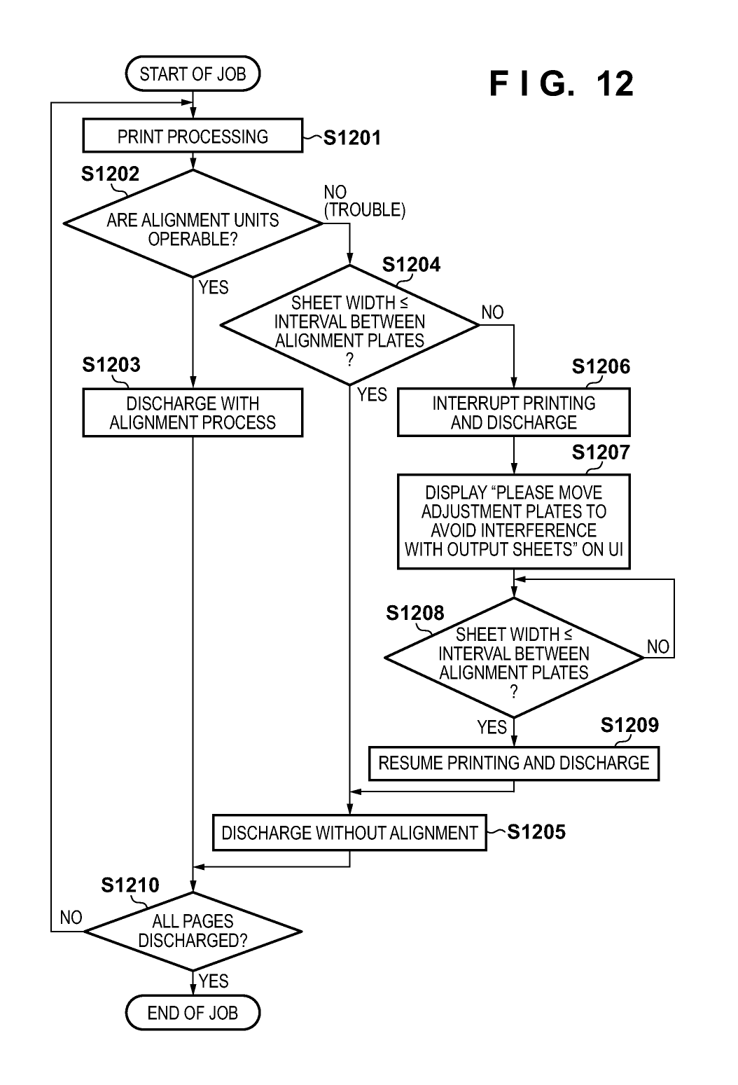

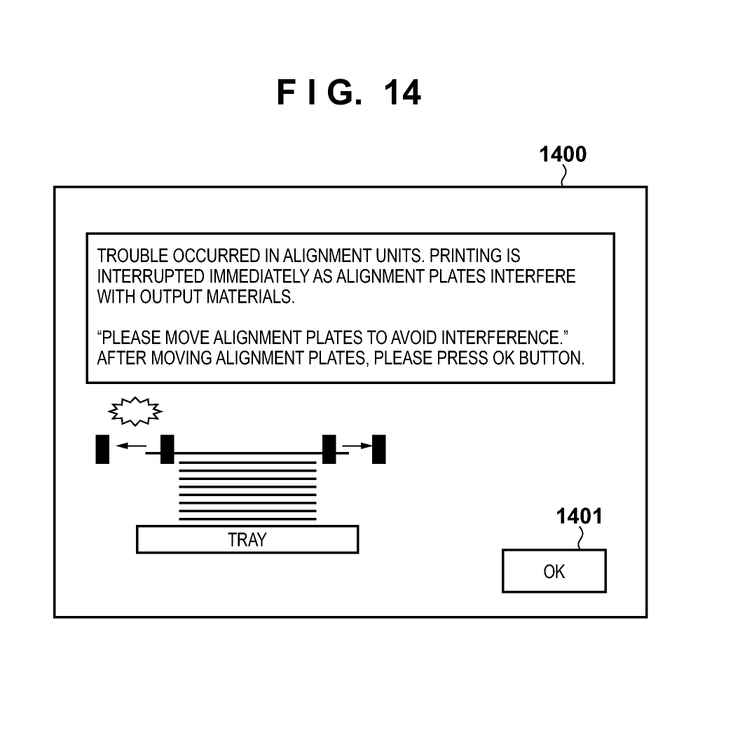

A description is now given of the first embodiment of the present invention with reference to FIGS. 12 and 14. First, a flow of processing executed by the CPU 901 and the CPU 952 in the finisher control unit 951 in the present embodiment is described with reference to FIG. 12. The following describes the exemplary case where sheets are discharged onto an upper tray. The CPU 901 operates in accordance with programs stored in the ROM 902, and the CPU 952 operates in accordance with programs stored in the ROM 953. The flowchart of FIG. 12 is started when the start key 402 is pressed on the operation display unit 400, or when accepting a print instruction and image data from the external computer 905.

In S1201, the CPU 952 in the image forming apparatus 10 starts print processing. More specifically, when the start key 402 is pressed on the operation display unit 400, the CPU 952 causes the scanner unit 104 to read an image of an original, and stores the read image of the original in the storage unit 961. When image data to be printed on sheets has been prepared, the CPU 952 starts printing for each sheet. On the other hand, when a print instruction and image data are accepted from the external computer 905, the CPU 952 stores the image data in the storage unit 961. When image data to be printed on sheets has been prepared, the CPU 952 starts printing for each sheet. In S1202, the CPU 952 determines whether or not trouble has occurred in the upper tray alignment motors M9 and M10 (whether the upper tray alignment motors M9 and M10 are operable or inoperable) based on the trouble detecting sensor 740 (hereinafter, the upper tray alignment motors M9 and M10 are referred to as alignment units). When no trouble has occurred in the alignment units, the processing moves to S1203. When the CPU 952 determines that trouble has occurred in the alignment units in S1202 the processing moves to S1204. For example, when sheets are discharged onto the upper tray, the CPU 952 makes the determination regarding the trouble based on the trouble detecting sensor 740. More specifically, the CPU 952 determines that trouble has occurred in the alignment units when the trouble detecting sensor 740 detects a state where the upper tray alignment motors M9 and M10 are not operating even though the CPU 952 has issued an operation instruction thereto, or a state where the positions of the alignment plates do not change even though the upper tray alignment motors M9 and M10 are operating.

In S1203, as no trouble has occurred in the alignment units, the CPU 901 normally controls the finisher control unit 951 so as to apply the alignment operations to discharged sheets, and proceeds to S1210. On the other hand, in S1204, the CPU 952 acquires the sheet width W from the sheet information notified from the CPU 901, calculates the interval D between the alignment plates, and compares the sheet width W with the interval D between the alignment plates. When the sheet width is smaller than or equal to the interval between the alignment plates (W≦D), the processing moves to S1205. When the sheet width is larger than the interval between the alignment plates (W>D), the processing moves to S1206. Note that the CPU 952 acquires the interval D between the alignment plates by acquiring the current positions of the alignment plates 711a and 711b and calculating D=∥X1−X2∥. When trouble has occurred while the alignment plates are located at the alignment waiting positions, the interval D between the alignment plates satisfies the relationship D=W+2M. When trouble has occurred while the alignment plates are executing the alignment operations, the interval D between the alignment plates fluctuates within the range W≦D≦W+2M.

In S1205, the CPU 901 controls the finisher control unit 951 to discharge sheets without applying the alignment operations to the discharged sheets, then proceeds to S1210. On the other hand, in S1206, the CPU 901 controls the printer control unit 931 and the finisher control unit 951 to interrupt the printing and discharge operations, then proceeds to S1207. In S1207, the CPU 901 controls the operation display control unit 941 to display a screen 1400 shown in FIG. 14 on a display screen. Thereafter, the processing moves to S1208. In S1208, when the trouble detecting sensor 740 detects that the user has moved the alignment plates to positions where the alignment plates do not interfere with the discharged sheets, that is to say, when the sheet width W the interval D between the alignment plates, the CPU 901 proceeds to S1209. The CPU 901 repeatedly executes the process of S1208 until the user moves the alignment plates to positions where the alignment plates do not interfere with the discharged sheets. More specifically, the CPU 952 compares the sheet width W with the interval D between the alignment plates and keeps waiting until the relationship W≦D is satisfied.

For example, the CPU 901 controls the operation display control unit 941 to display the screen shown in FIG. 14 on the display screen. The CPU 901 also controls the operation display control unit 941 so as to disable pressing of a confirmation button 1401. Then, the CPU 952 acquires the sheet width W from the sheet information notified from the CPU 901 and calculates the interval D between the alignment plates. Upon satisfaction of the relationship W≦D, the CPU 901 controls the operation display control unit 941 to enable pressing (selection) of the confirmation button 1401 on the display screen 1400. When the CPU 901 detects that the confirmation button 1401 has been pressed, the processing moves to S1209. Alternatively, in the case where the confirmation button 1401 is not provided, the processing may automatically move to S1209 when the CPU 901 determines that the relationship W≦D is satisfied.

In S1209, the CPU 901 controls the printer control unit 931 and the finisher control unit 951 to resume printing and discharge, then proceeds to S1205. In S1205, the CPU 901 controls the finisher control unit 951 to discharge sheets without applying the alignment operations to the discharged sheets, then proceeds to S1210.

In S1210, the CPU 901 determines whether or not all pages (sheets) have been discharged. When all pages have been discharged, the CPU 901 ends the job. On the other hand, when the CPU 901 determines in S1210 that discharge is still in process, the processing returns to S1201, and the CPU 901 and the CPU 952 execute the sequence of processes.

As described above, in the present embodiment, when trouble has occurred in the alignment units (alignment plates), the interval between the alignment plates is compared with the sheet width at the time of the trouble, and the discharge operations are switched in accordance with the result of the comparison. More specifically, when the result of the comparison shows that the sheet width is larger than the interval between the alignment plates, printing and discharge operations that are currently in execution are interrupted, and the operator is notified of guidance for moving the alignment plates to positions where the alignment plates do not interfere with discharged sheets. Thereafter, once the alignment plates have been moved by the operator, the interrupted printing and discharge operations are resumed. In this way, when trouble has occurred in the alignment units, the present embodiment allows preventing problems caused by interference between the alignment plates and output sheets (a paper jam and damage to the output materials). In the example described in the above embodiment, the print processing is started in S1201 before the alignment units are determined to be operable in S1202. However, the present invention is not limited in this way. Alternatively, the printing may be started after the alignment units are determined to be operable. Also, in the above-described example, the print processing is started in S1201 before the sheet width is determined to be smaller than or equal to the interval between the alignment plates (W≦D) in S1204. However, the present invention is not limited in this way. Alternatively, printing may be started after the alignment units are determined to be operable in S1202 and the sheet width is determined to be smaller than or equal to the interval between the alignment plates (W≦D) in S1204.

### Second Embodiment

### Discharge Operations Executed when Trouble Occurs in Alignment Units

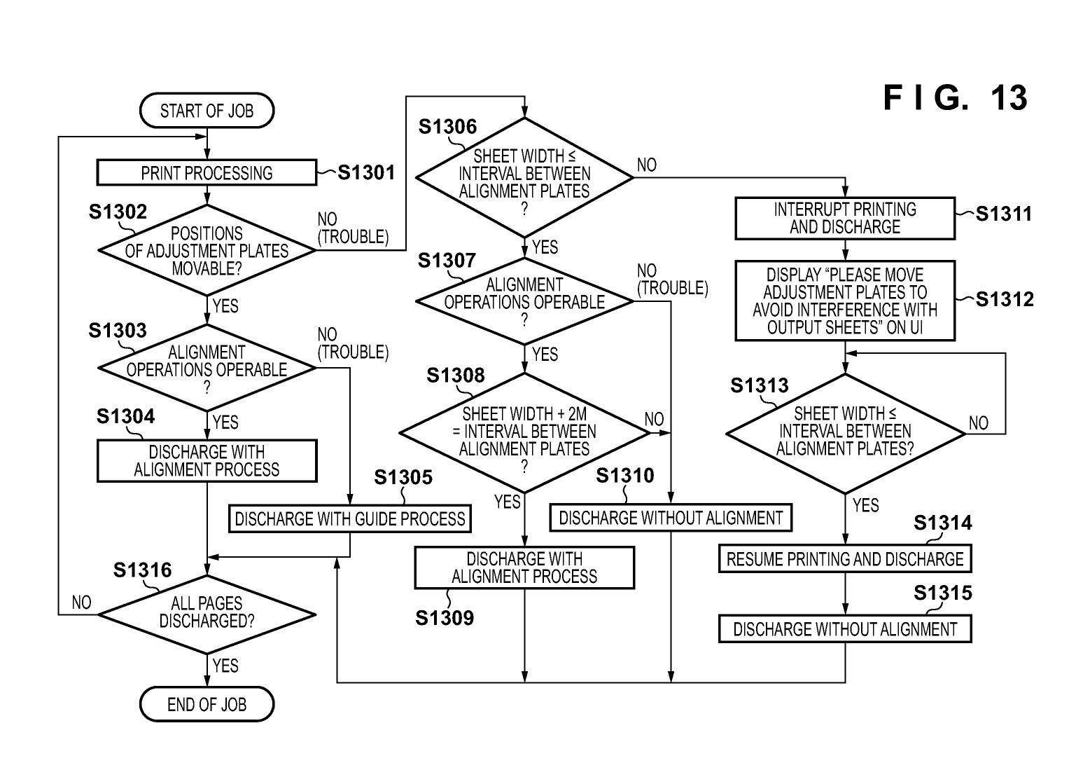

A description is now given of the second embodiment of the present invention with reference to FIG. 13. In the above-described first embodiment, regardless of the level of trouble, sheets are discharged without applying the alignment operations thereto. The present embodiment switches to applicable alignment operations in accordance with the level of trouble in the alignment units so as to improve the stacking performance to the fullest, even when trouble has occurred in alignment motors. For example, in the case where trouble in the alignment motors does not allow control of the alignment operations (subtle and quick control of the alignment plates) but allows moving the positions of the alignment plates (control of unsubtle movements of the alignment plates), the stacking performance can be improved by controlling the alignment plates as discharge guides even when trouble has occurred. Below is a description of processing according to the present embodiment with reference to the flowchart of FIG. 13. The following describes the exemplary case where sheets are discharged onto an upper tray. The flowchart of FIG. 13 is started when the start key 402 is pressed on the operation display unit 400, or when accepting a print instruction and image data from the external computer 905.

In S1301, the CPU 952 in the image forming apparatus 10 starts print processing. More specifically, when the start key 402 is pressed on the operation display unit 400, the CPU 952 causes the scanner unit 104 to read an image of an original, and stores the read image of the original in the storage unit 961. When image data to be printed on sheets has been prepared, the CPU 952 starts printing for each sheet. On the other hand, when a print instruction and image data are accepted from the external computer 905, the CPU 952 stores the image data in the storage unit 961. When image data to be printed on sheets has been prepared, the CPU 952 starts printing for each sheet. In S1302, the CPU 952 detects whether or not trouble has occurred in the alignment units based on the trouble detecting sensor 740, and determines whether or not the positions of the alignment plates can be moved. When the CPU 952 determines that the positions of the alignment plates can be moved, the processing moves to S1303. When the CPU 952 determines that trouble has occurred in the alignment units and the positions of the alignment plates cannot be moved, the processing moves to S1306. As to the determination regarding the trouble, the CPU 952 determines whether or not the positions can be moved in consideration of, for example, the states of the upper tray alignment motors M9 and M10 and a timing at which the trouble was detected by the trouble detecting sensor 740. More specifically, in the case where trouble in the alignment units is detected when performing control to move the alignment plates from the default positions to the alignment plate waiting positions, the CPU 952 determines that the movement of the positions cannot be controlled. Examples of such trouble include a state where the upper tray alignment motors M9 and M10 do not operate even though the CPU 952 has issued an operation instruction thereto, and a state where the positions of the alignment plates do not change even though the upper tray alignment motors M9 and M10 are operating.

In S1303, the CPU 952 detects whether or not trouble has occurred in the alignment operations based on the trouble detecting sensor 740, and determines whether or not the alignment operations of the alignment plates can be controlled. When the CPU 952 determines that the alignment operations of the alignment plates can be controlled, the processing moves to S1304. When the CPU 952 determines that trouble has occurred in the alignment units and the alignment operations of the alignment plates cannot be controlled, the processing moves to S1305. As to the determination regarding the trouble, the CPU 952 determines whether or not the positions can be moved in consideration of, for example, the states of the upper tray alignment motors M9 and M10 and a timing at which the trouble was detected by the trouble detecting sensor 740. More specifically, in the case where trouble in the alignment units is detected when the CPU 952 attempts to control the alignment operations of the alignment plates, the CPU 952 determines that the alignment operations cannot be controlled. Furthermore, depending on the types of the motors, the CPU 952 may determine whether the trouble has occurred during the alignment operations or the trouble is attributed to control of the movement with reference to voltage for operating the motors.

In S1304, the CPU 901 controls the finisher control unit 951 to apply the alignment operations to discharged sheets, then proceeds to S1316. On the other hand, in S1305, the CPU 952 acquires the sheet width W from the sheet information notified from the CPU 901, performs discharge control to move the alignment plates and use them as discharge guides, then proceeds to S1316. For example, the positions X1 and X2 of the alignment plates 711a and 711b are moved so that the interval D between the alignment plates equals W, with its center position being the center position of the tray+the shift amount Z. The CPU 952 performs discharge control so that sheets are discharged between the alignment plates 711a and 711b that serve as discharge guide members. At this time, the interval D between the alignment plates 711a and 711b may have leeway, i.e. satisfy the relationship D=W+E, in consideration of error E in the discharge position (E>0) and the stacking performance of the guides.

Regarding S1306 and subsequent processes, some parts are similar to the processes of S1204 to S1210 in FIG. 12. Therefore, the following describes only the differences from the processes of S1204 to S1210 in FIG. 12. More specifically, the processes of S1311 to S1315 are similar to the processes of S1205 to S1209 in FIG. 12, and therefore a description thereof is omitted.

In S1307, the CPU 952 detects whether or not trouble has occurred in the alignment units based on the trouble detecting sensor 740, and determines whether or not the alignment operations of the alignment plates can be controlled. When the CPU 952 determines that the alignment operations of the alignment plates can be controlled, the processing moves to S1308. When the CPU 952 determines that trouble has occurred in the alignment units, and the alignment operations of the alignment plates cannot be controlled, then the processing moves to S1310. In S1308, the CPU 952 acquires the sheet width W from the sheet information notified from the CPU 901, calculates the interval D between the alignment plates, and compares the sheet width W with the interval D between the alignment plates. It is assumed here that the interval D between the alignment plates satisfies the relationship D=W+2M. When the sheet width W+2M=the interval D between the alignment plates, the processing moves to S1309. Note, M denotes a position that is distant from the side surfaces of discharged sheets parallel to the conveyance direction approximately by a distance that allows the alignment units to make the alignment plates execute a process for hitting the side surfaces (alignment process). That is to say, in the present example, 2M is added to the sheet width because the two alignment members need to be distant from both side surfaces by approximately M each. The value of M is set to an arbitrary value in accordance with the forms of the alignment members. On the other hand, when the sheet width W+2M≠the interval D between the alignment plates, the processing moves to S1310. In S1309, the CPU 901 controls the finisher control unit 951 to apply the alignment operations to discharged sheets, because the alignment operations can be executed even though trouble has occurred in the alignment units, and the positions of the alignment units correspond to the sheet width.

On the other hand, S1310 is a step for the case where the alignment operations can be executed even though trouble has occurred in the alignment units, but sheets cannot be aligned or the output materials may be damaged by the alignment operations because the alignment plates do not have an appropriate interval therebetween. In S1310, the CPU 901 controls the finisher control unit 951 so as not to apply the alignment operations to the discharged sheets. The processes of S1311 to S1316 are the same as the processes of S1205 to S1210 in FIG. 12, and therefore a description thereof is omitted.

As described above, when trouble has occurred in the alignment units for some reason, the sheet processing apparatus according to the present embodiment switches the alignment operations based on whether or not the positions of the alignment plates can be moved and whether or not the alignment operations can be executed. More specifically, in the case where the positions of the alignment plates can be moved and the alignment operations can be executed, the sheet processing apparatus according to the present embodiment normally executes the alignment operations. In the case where the positions of the alignment plates can be moved and the alignment operations cannot be executed, the sheet processing apparatus moves the alignment plates to guide positions for discharge processing and uses the alignment plates as guide members. In the case where the positions of the alignment plates cannot be moved and the alignment operations can be executed, the sheet processing apparatus performs control to execute the alignment operations when the alignment plates are located at positions for the alignment process, and not to execute the alignment operations when the alignment plates are not located at positions for the alignment process. As set forth above, the present embodiment divides up the alignment operations executed after the determination regarding the trouble in the alignment units described in the first embodiment, based only on whether or not the positions of the alignment plates can be moved. This enables more specific control of the alignment operations. In the example described in the present embodiment, the print processing is started in S1301. However, the present invention is not limited in this way. Alternatively, print processing for the first sheet may be started in S1304, S1305, S1309, S1310 or S1314.

### Other Embodiments

The present invention is not limited to the above-described embodiments, and various modifications may be made. The above embodiments have described control on the stack tray 701, namely the upper tray, for the case where trouble has occurred in the alignment units for the stack tray 701. However, the present invention is not limited in this way. Alternatively, for example, when trouble has occurred in the alignment units for the upper tray, a discharge destination for sheets may be switched to the stack tray 700, namely the lower tray. In this case, when sheets are discharged without being aligned due to trouble in the alignment units, the above-described embodiments may allow control to switch to the lower tray if possible.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-243852 filed on Nov. 5, 2012, which is hereby incorporated by reference herein in its entirety.

1. A sheet processing apparatus, comprising:
a stacking control unit configured to control to stack sheets on a sheet stacking unit;
an alignment control unit configured to control to align, by a plurality of alignment members, the sheets stacked on the sheet stacking unit
a determination unit configured to determine whether or not the alignment members can align sheets; and
a control unit configured to prompt, in a case where the determination unit determines that the alignment members cannot align sheets, a user to move the alignment members.

2. The sheet processing apparatus according to claim 1, wherein
the alignment control unit configured to control, in a case where the determination unit determines that the alignment members can align sheets, the alignment members to align the sheets stacked on the sheet stacking unit.

3. The sheet processing apparatus according to claim 1, further comprising:
a comparison unit configured to compare the width of the sheets to be stacked on the sheet stack unit with the interval between the alignment members; and
wherein the stacking control unit controls,
in a case where the determination unit determines that the alignment members cannot align sheets and a result of the comparison by the comparison unit shows that the width of the sheets is smaller than or equal to the interval between the alignment members, to stack the sheets on the sheet stacking unit without aligning the sheets by the alignment members

4. The sheet processing apparatus according to claim 1, wherein the control unit prompts the user to move the alignment members so that the width of the sheets becomes smaller than or equal to the interval between alignment members.

5. The sheet processing apparatus according to claim 1, wherein
the determination unit further determines whether or not positions of the alignment members are movable, and
in a case where the alignment members cannot align sheets and the positions of the alignment members are movable, the alignment control unit moves the alignment members, the alignment members being used as guide members for discharging the sheets onto the sheet stack unit.

6. The sheet processing apparatus according to claim 5, wherein
in a case where the alignment members can align sheets and the positions of the alignment members are not movable, the control unit further performs control so that
the alignment process is executed when the interval between the alignment members has a length necessary to align sheets, and
the alignment process is not executed when the interval between the alignment members does not have a length necessary to align sheets.

7. The sheet processing apparatus according to claim 5, wherein
in a case where the positions of the alignment members are not movable and the width of the sheets is larger than the interval between the alignment members, the control unit further performs control to interrupt discharge of the sheets, prompt the user to move the alignment members so that the width of the sheets becomes smaller than or equal to the interval between the alignment members, and resume the discharge of the sheets without aligning sheets when the width of the sheets becomes smaller than or equal to the interval between the alignment members.

8. The sheet processing apparatus according to claim 1, wherein
the control unit controls to interrupt discharge of the sheets, display on a display unit a display screen for prompting the user to move the alignment members, and resume the discharge of the sheets without aligning sheets when a button displayed on the display screen is selected, and
the button is selectable when the width of the sheets is smaller than or equal to the interval between the alignment members.

9. The sheet processing apparatus according to claim 1, wherein
the control unit further performs control to
instead of discharging the sheets without aligning sheets, discharge the sheets onto another sheet stacking unit, and
control other alignment members to align the sheets stacked on the other sheet stacking unit.

10. The sheet processing apparatus according to claim 1, wherein the alignment control unit controls to align, by the plurality of alignment members, the sheets stacked on the sheet stacking unit by coming into contact with side surfaces of the stacked sheets.

11. A control method comprising:
controlling to stack sheets on a sheet stacking unit;
controlling to align, by a plurality of alignment members, the sheets stacked on the sheet stacking unit;
determining whether or not the alignment members can align sheets; and
prompting,
in a case where the alignment members cannot align sheets, a user to move the alignment members.

12. A non-transitory computer-readable storage medium storing a computer program for causing a computer to execute the control method for the sheet processing apparatus according to claim 11.
